(19) United States
(12) Patent Application Publication
(10) Pub. No.: US 2016/0108889 A1
(43) Pub. Date: Apr. 21, 2016

(54) BLADE ANGLE CONTROL APPARATUS OF WIND POWER GENERATOR AND WIND POWER GENERATOR HAVING SAME

(71) Applicant: Jinhwan KIM, Gyeonggi-do (KR)

(72) Inventor: Jinhwan KIM, Yongin-si, Gyeonggi-do (KR)

(21) Appl. No.: 14/787,906

(22) PCT Filed: Apr. 23, 2014
(86) PCT No.: PCT/KR2014/003533

§ 371 Date: Oct. 29, 2015

(30) Foreign Application Priority Data
May 29, 2013 (KR) 10-2013-0061351

(51) Int. Cl. F03D 7/02; F03D 1/06

(52) U.S. Cl. CPC F03D 7/0236; F03D 1/0675; F03D 11/0075

(57) ABSTRACT

An apparatus for controlling a blade angle of a wind power generator according to wind velocity, and a wind power generator having the same, the apparatus comprising: a shaft; a housing provided to enable the rotation of the shaft; and a spring having ends fixed respectively to the shaft and the housing to store elastic energy through the relative rotation of the shaft and the housing, and enables the relative rotation in the reverse direction so as to restore the shift and the housing to the original states when the power necessary for the relative rotation is released, wherein one of the shat and the housing is fixed at a blade provision unit provided to rotate the blade by using wind pressure and the other is fixed at the blade.

### BACKGROUND

The present invention relates to a blade angle control apparatus of a wind power generator and a wind power generator having the same, and in particular to a blade angle control apparatus of a wind power generator and a wind power generator having the same which are able to change the angle of a blade according to wind velocity.

A wind power generator is an apparatus which is able to convert energy obtained from wind resource into a rotational kinetic energy and then into an electric energy.

Such a wind power generator consists of a rotor which rotates by wind, a nacelle which is able to convert rotational force of the rotor into electricity, and a tower which supports the nacelle and rotor. The rotor equips with a plurality of blades which generate rotational force with the aid of wind and is installed rotatable at the nacelle. In addition, the nacelle may include a gear box configured to transfer torque to the rotor, and a generator which may operate by the torque. The tower is installed vertical at an installation place to support the weight of the nacelle and the rotor which are installed on its top.

In case of such a wind power generator, one specific structure may not well operate withstanding all the wind since winds flows in various directions or with intensities based on the installation place. To this end, it needs to provide a wind power generator having a structure which may provide high efficiency while being suitable to a specific region and place. For example, if the width of each blade of a wind power generator is made wide, such a configuration may be good to use low velocity wind, but bad to use strong wind. In particular, in case of a horizontal shaft type blade which may allow to change the whole angles of each blade, the rotational angle in the rotating direction may change, which may consequently cause any problems in terms of safety, due to vibration, etc. during the rotation of the rotor. For this reason, a wind power generator and its structure which may use both strong and weak wind with the aid of a wide area blade are necessary.

In order to resolve the above problems, as a conventional art, there are provided the Korean utility model registration number 20-0459015 (registered on Feb. 27, 2012) entitled “blade angle control apparatus for wind power generator” and the Japanese utility model registration number 3002361 (registered on Jul. 13, 1994) entitled “water power windmill”. These conventional technologies are configured in such a way that any danger of strong wind can be avoided by adjusting the angles of each blade when the blades of the horizontal shaft wind power generator rotates based on wind velocity. In order to adjust the angles of each blade based on strong and weak levels of wind, a hinge is used. When the angles of each blade change, the whole angles of the rotor and the nacelle will change. The wide area blade is advantageous if wind is weak, but disadvantageous if wind is strong. To this end, the angle of the blade is changed so as to prevent any disadvantage at strong wind. The hinge may not allow to control force at the changing time of the blade matching with the area of the blade and wind velocity. In particular, in case of the horizontal shaft type blade wherein the shaft of the rotor is horizontal, if the whole angles of each blade change, the angles of the rotation directions of each blade may change, thus causing any problem in terms of safety of blades.

### SUMMARY OF THE INVENTION

Accordingly, it is an object of the present invention to provide a blade angle control apparatus of a wind power generator and a wind power generator having the same wherein it is possible to generate high torque with respect to gentle wind and strong wind in such a way to provide quick and stable rotations to control the area where each blade receives wind pressure based on the level of wind velocity, and the areas of such blades can be stably controlled. These objects of the present invention will be better understood along with the descriptions below.

To achieve the above objects, according to one aspect of the present invention, there is provided a blade angle control apparatus of a wind power generator which is able to control the angle of a blade of the wind power generator based on wind velocity, which may include, but is not limited to, a shaft; a housing wherein the shaft is installed rotatable; and a spiral spring the ends of which are fixed at the shaft and the housing, thus storing an elastic energy based on relative rotation between the shaft and the housing, and if the force necessary for the relative rotation is removed, the spiral spring allows the shaft and the housing to relatively rotate in the opposite directions to return to their initial states, and any of the shaft and the housing is fixed at a blade installation part installed in such a way that the blade can rotate by wind pressure, and the other one is fixed at the blade, whereupon the area of the blade which receives wind pressure can be adjusted based on the level of wind velocity with the aid of the elastic force of the spiral spring.

The shaft is fixed in the longitudinal direction at the blade installation part disposed at the hub while extending in the radial direction about the hub of the wind power generator, and the housing is arranged in such a way that a blade fixing plate fixed at the blade can protrude from a side portion.

The spiral spring is installed in the inside of the housing while covering the shaft wherein one end of the spiral spring is fixed at the shaft, and the other end thereof is fixed at an inner side surface of the housing, and the shaft is supported rotatable by a bearing installed in the inside of the housing to position at both sides of the spiral spring.

There are further provided a stopper which is arranged protruding from the shaft; and an engaging piece which is installed in the housing and in a rotation trajectory of the stopper and is hooked by the stopper in such a way that the area which receives wind pressure with respect to the blade does not get out of a predetermined size, and the engaging piece is selectively fixed at any of multiple positions within the rotation trajectory, and the maximum size of the area that the blade receives wind pressure can be adjusted.

To achieve the above objects, according to another aspect of the present invention, there is provided a wind power generator having a blade angle control apparatus, which may include, but is not limited to, a hub which is installed rotatable at a nacelle; a blade installation part which extends in a radial direction about the hub and is fixed in such a way that its rotation can be inhibited; a blade angle control part which is installed at the blade installation part; and a blade which is fixed at the blade angle control part, wherein the blade angle control part is formed of a blade angle control apparatus of a wind power generator recited in any of claims 1 to 4.

The blade angle control part is installed multiple in number in the longitudinal direction at regular intervals at the blade installation part, each of the blade angle control parts being fixed at a side portion of the blade, and the blade installation part includes a blade angle control apparatus which positions at a front side of the blade with respect to wind direction.

According to the blade angle control apparatus of a wind power generator and a wind power generator with the same, the area of each blade which receives wind pressure based on the level of wind velocity can be controlled, and torque can be stably obtained with gentle wind or strong wing. Any damages to components including each blade can be prevented with respect to even strong wind. The blades can quickly and stably rotate with respect to any changes in wind velocity. It is easy to control the change in area of each blade which receives wind pressure based on wind velocity and the rotation timing of each blade, and the present invention can apply to both the horizontal shaft type and the vertical shaft type based on any conditions at installation places and regions.

### BRIEF DESCRIPTION OF DRAWINGS

FIG. 1 is a side view illustrating a wind power generator which equips with a blade angle control apparatus according to a first exemplary embodiment of the present invention.

FIG. 2 is a side view for describing the operation of a wind power generator which equips with a blade angle control apparatus according to a first exemplary embodiment of the present invention.

FIG. 3 is a perspective view illustrating a blade angle control apparatus of a wind power generator according to an exemplary embodiment of the present invention.

FIG. 4 is a side cross sectional view illustrating a blade angle control apparatus of a wind power generator according to an exemplary embodiment of the present invention.

FIG. 5 is a front cross sectional view illustrating a blade angle control apparatus of a wind power generator according to an exemplary embodiment of the present invention.

FIG. 6 is a perspective view illustrating an inner configuration of a blade installation part while illustrating a wind power generator which equips with a blade angle control apparatus according to a first exemplary embodiment of the present invention.

FIG. 7 is a cross sectional view illustrating a blade installation part while illustrating a wind power generator which equips with a blade angle control apparatus according to a first exemplary embodiment of the present invention.

FIG. 8 is a side view illustrating a blade and a blade installation part of a wind power generator which equips with a blade angle control apparatus according to a first exemplary embodiment of the present invention.

FIG. 9 is a side view illustrating a blade and a blade installation part of a wind power generator which equips with a blade angle control apparatus when viewing in the opposite direction according to a first exemplary embodiment of the present invention.

FIG. 10 is a front cross sectional view for describing the operation of a blade angle control apparatus of a wind power generator according to a first exemplary embodiment of the present invention.

FIG. 11 is a side view illustrating a major compartment of a wind power generator which equips with a blade angle control apparatus according to a second exemplary embodiment of the resent invention.

FIG. 12 is a side view illustrating an inner configuration of a blade installation part of a wind power generator which equips with a blade angle control apparatus according to a second exemplary embodiment of the present invention.

### DETAILED DESCRIPTION OF THE INVENTION

The present invention may be changed into various forms and may have various examples, and specific examples are illustrated in the drawings and will be described, which are not intended to limit thereto. Such disclosures should be interpreted as including all modifications, equivalents or substitutes which are included in the technical concepts and ranges of the present invention and may be modified into various forms, which is not intended to limit the scope of the present invention.

The embodiments of the present invention will be described with reference to the accompanying drawings. The same or corresponding components will be given the same reference numbers, and the repeated descriptions thereon will be omitted.

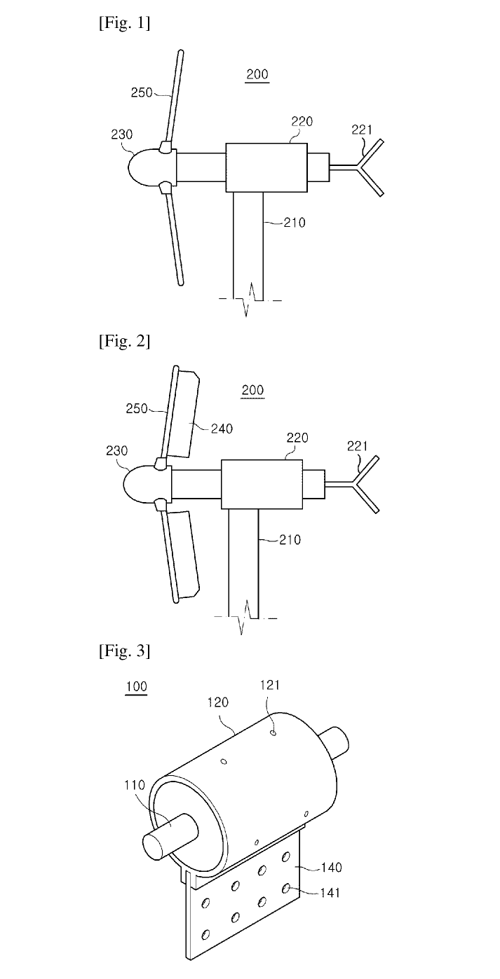

FIG. 1 is a side view illustrating a wind power generator which equips with a blade angle control apparatus according to a first exemplary embodiment of the present invention. FIG. 2 is a side view for describing the operation of a wind power generator which equips with a blade angle control apparatus according to a first exemplary embodiment of the present invention. FIG. 3 is a perspective view illustrating a blade angle control apparatus of a wind power generator according to an exemplary embodiment of the present invention.

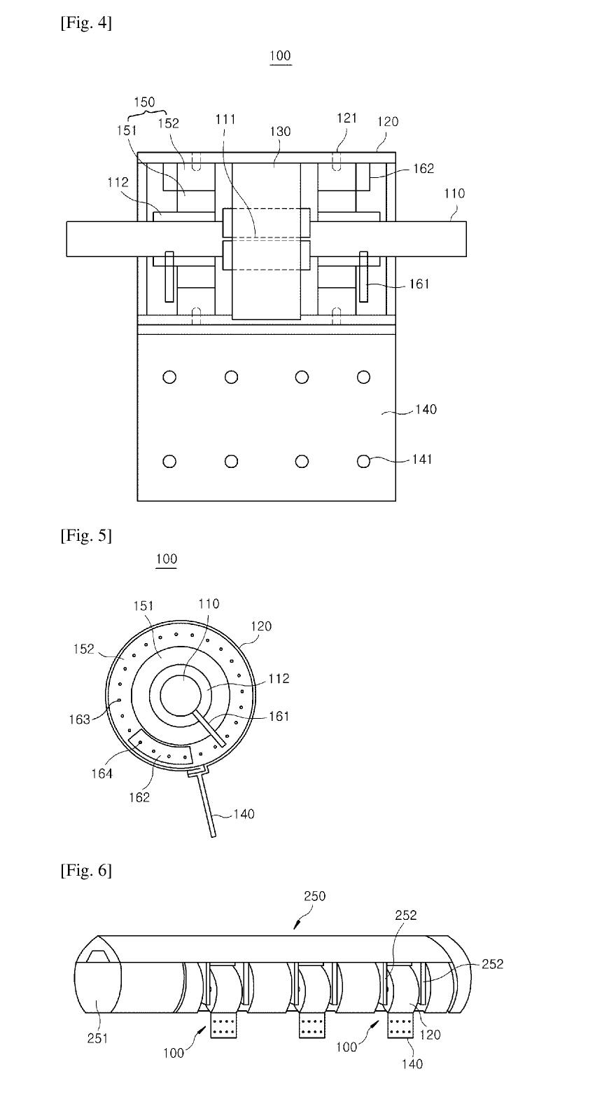

As illustrated in FIGS. 1 to 3, the blade angle control apparatus 100 of a wind power generator according to an exemplary embodiment of the present invention is an apparatus which is able to adjust the angle of each blade 240 of a wind power generator 200, namely, the pitches thereof and may include, but is not limited to, a shaft 110, a housing 120 and a spiral spring 130 (as illustrated in FIG. 4). Any of the shaft 110 and the housing 120 is fixed at a blade installation part 250 which is installed in such a way that the blade 240 to rotate by wind pressure, and the remaining one is fixed at the blade 240. To this end, the area of the blade 240 which receives wind pressure can be adjusted based on the level of wind velocity by the elastic force of the spiral spring 130 (in FIG. 4). Here, the area of the blade 240 which receives wind pressure may be designed as an area which the blade 240 occupies with respect to the direction which is orthogonal to the wind direction.

As illustrated in FIG. 4, the shaft 110 may be installed passing through the housing 120, whereupon it can be installed relatively rotatable with respect to the housing 120. Here, the relative rotation between the shaft 110 and the housing 120 means that any of the shaft 110 and the housing 120 is fixed, and the remaining one is rotatable.

The housing 120 may be installed around the shaft 110 in such a way that the shaft 110 is rotatable and may have a cylindrical shape which can provide an inner space as in the present embodiment, wherein the shaft 110 is installed passing through both sides of the housing 120.

The ends of the spiral tape 130 are fixed at the shaft 110 ad the housing 120, whereupon elastic energy can be stored with the aid of a relative rotation between the shaft 110 and the housing 120. If force which is necessary for the relative rotation is all or partially lifted, namely, if the stored elastic energy is larger than the force which may apply to the blade 240 by wind pressure, a relative rotation in the opposite direction may occur, which may allow the shaft 110 and the housing 120 to return to their original states.

The spiral spring 130 may be installed in the inside of the housing 120 in such a way to cover the shaft 110 in a state where one end of the shaft 110 is fixed, and the other end may be fixed at an inner side surface of the housing 120. For this, the shaft 110 may has a spiral tape fixing part 111 on its outer circumference so that an end defined in the center of the spiral spring 130 is fixedly inserted. In addition, the housing 120 may equip with a spiral spring fixing part (not illustrated) on its inner side surface so that an edge end of the spiral tape 130 can be fixedly inserted.

The shaft 110 may be supported rotatable by means of a bearing 150 which is installed in the housing 120 so that it can position at both sides of the spiral spring 130. The bearing 150 may include, but is not limited to, an inner race 151 which is fixed on an outer circumference of the shaft 110, and an outer race 152 which is engaged rotatable to an outer side of the inner race 151 with the aid of a ball, a roller, etc. and is finally fixed on an inner circumference of the housing 120 using a fixing bolt 121. Meanwhile, the inner race 151 may be fixed on an outer circumference of the shaft 110 with the aid of a sleeve 112.

In the embodiments in FIGS. 6 and 8, the shaft 110 may be fixed in the longitudinal direction at the blade installation part 250 disposed at a hub 230, in such a way to extend in a radial direction about the hub 230 of the wind power generator 200. The housing 120 may be disposed in such a way that a blade fixing plate 140 fixed at the blade 240 protrudes from a side portion. The blade fixing plate 140 may be provided integral with the housing 120 or separate from the housing 120, so it can vertically fit into the outer circumference of the housing 120 by various methods, for example, a fixing method, a side engaging method, a riveting method, a welding method, etc. Here, the blade installation part 250 may not be provided separate as in the present embodiment, but may be a hub 230. In this case, the shaft 110 may be directly fixed at the hub 230 so that the blade 240 can be installed directly rotatable at the hub 230.

There may be provided a stopper 161 and an engaging piece 162 so as to limit the angle, namely, the pitch with respect to the blade 240. Here, the stopper 161 may be provided in such a way to protrude from the shaft 110 may be provided in a form of a bar. The engaging piece 162 may be installed in the inside of the housing 120 in such a way to position within a rotation trajectory of the stopper 161 and may be hooked by the stopper 161 in such a way that the area which receive wind pressure does not get out of a predetermined size with respect to the blade 240 which rotates by the elastic force of the spiral tape 130.

Referring to FIG. 5, the engaging piece 162 maybe selectively fixed at any of multiple positions defined on a rotation trajectory of the stopper 161 with the aid of the rotation of the shaft 110, whereupon the blade 240 may allow to adjust the maximum size of the area which receives wind pressure. For example, the engaging piece 162 may be fixed on the outer race 152. Here, the outer race 152 may include a plurality of engaging grooves 164 in the circumferential direction, whereupon the engaging piece 162 may be selectively fixed at one of the engaging grooves 164 by means of a fixing bolt 163. For this reason, the engaging piece 162 may limit the loosening of the spiral spring 130 in such a way to adjust the allowable rotation angle of the stopper 161. At this time, the stopper 160 may be configured to rotate by 160°˜200° from the initial position, wherein the angle may be 60°˜80°, preferably 70°.

As illustrated in FIGS. 1 and 2, the wind power generator 200 which equips with the blade angle control apparatus according to the first exemplary embodiment of the present invention may include the blade angle control apparatus 100 of a wind power generator. For example, there may be provided a hub 230 which is installed rotatable at the nacelle 220; a blade installation part 250 which may extend in the radial direction about the hub 230 and may be fixed at the hub 230 for the sake of inhibition of rotation; a blade angle control part installed at the blade installation part 250; and a blade 240 fixed at the blade angle control part, wherein the blade angle control part, as described earlier, may be formed of the blade angle control apparatus 100 of the wind power generator according to the present invention. The wind power generator 200 having the blade angle control apparatus according to the first exemplary embodiment of the present invention may be a horizontal shaft type wind power generator wherein the shaft of the rotor is disposed horizontal.

The hub 230 may form the rotor together with the blade 240 and is installed rotatable at the nacelle 220 by a rotary shaft. Here, the nacelle 220 may include a tail wing 221 disposed at a tail portion in such a way to be arranged in a row and may be fixed on the tower 210. In addition, the nacelle 220 may include a gear box configured to transfer torque of the hub 230 which rotates by the blade 240 having resistance with respect to wind pressure; and a generator driven using torque from the gear box.

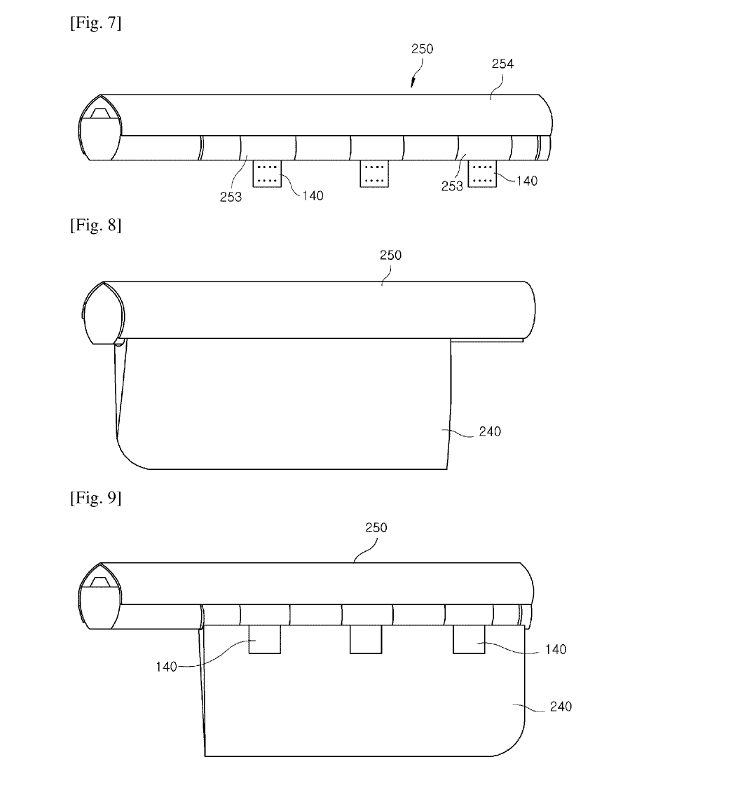

Referring to FIGS. 6 and 7, the blade installation part 250 may include a hub fixing part 251 for the sake of fixing at the hub 230. The blade angle control part, namely, the blade angle control apparatus 100 of a wind power generator may be provided multiple in number at regular intervals at the blade installation part 250. For this, the blade installation part 250 may include a plurality of accommodation spaces in the longitudinal direction at regular intervals to accommodate the blade angle control apparatus 100 of the wind power generator and may be fixed by a welding method or a protruded engagement method to prevent both ends of the shaft 110 (FIG. 4) from rotating by the shaft fixing part 252. A blocking plate 253 may be installed at an open side of the accommodation space so as to block the accommodation space. At this time, the blocking plate 253 may be fixed at the housing 120 and may rotate together with the housing 120 and may be sized and shaped to prevent any interference with the rotations of the housing 120.

A cover 254 may be engaged at one side of the blade installation part 350. This cover 254 is provided so as to protect the blade angle control apparatus 100 of the wind power generator as well as internal components and may be configured in such a way that its side is open in the longitudinal direction so as to prevent any interference with the rotations of the blade fixing plate 140 by the rotations of the housing 120.

The blade installation part 250 may be formed of a shaft member which is fixed at the hub 230. Since the blade installation part 125 may position in front of the blade 240 with respect to wind direction, it may form a head portion of the blade 240. To this end, if the blade 240 positions at a rear side of the blade installation part 250 and receives any resistance due to wind pressure, it may rotate like a tail wing with respect to the blade installation part 250.

Referring to FIGS. 8 and 9, each of the blade angle control parts, namely, the blade angle control apparatus 100 of a wind power generator may be fixed at a side portion of the blade 240. As mentioned earlier, it can be fixed at a side portion of the blade 240 with the aid of the blade fixing plate 140. The blade 240 may include a plurality of fixing grooves (not illustrated) in the longitudinal direction at regular intervals in such a way that the blade fixing plates 140 can be fixed along the side portion.

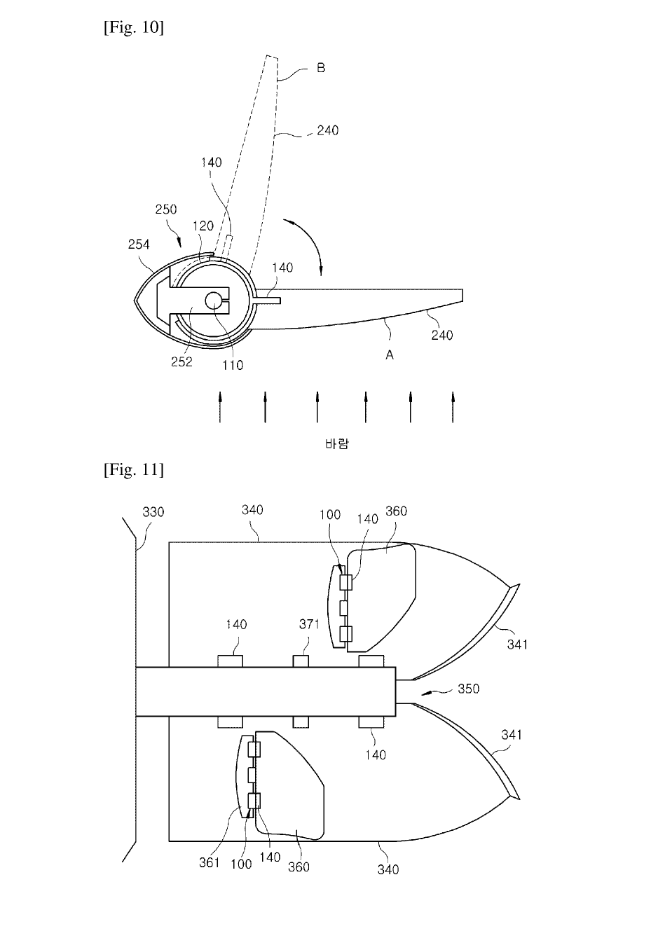

Referring to FIG. 10, the blade 240 may maintain a state “A” (FIG. 1) wherein the area which receives wind pressure increases due to the elastic force of the spiral spring 130 if wind velocity is relatively low since the elastic force provided by the spiral spring 130 (FIG. 4) of the blade angle control apparatus 100 of the wind power generator is relatively larger than the wind pressure that it receives. If the spiral spring 130 is loosened, the blade 40 may be set to maintain a rotational angle where the blade 240 can generate highest torque with the aid of the stopper 161 and the engaging piece 162 as in FIG. 5. This may be determined in consideration of the characteristics, for example, the wind velocity and the area or curvature of the blade 240.

In addition, the blade 240 may rotate in a state “B” (FIG. 2) where the spiral spring 130 is wound and then the area which receives wind pressure decreases if wind velocity is relatively high since the elastic force that the spiral spring 130 (FIG. 4) provides is relatively smaller than the wind pressure that it receives. To this end, any structural damages to the blade 240 and the rotor can be prevented in such a way to reduce resistance that the blade 240 receives by strong wind, and the blade 240 can generate a predetermined torque even with respect to strong wing. Meanwhile, if the wind velocity decreases, the elastic energy stored in the spiral spring 130 (FIG. 4) is transferred through the shaft 110 and the blade fixing plate 140 to the blade 240, whereupon the blade 240 will automatically turn to the state “A” (FIG. 1) where the area which receives wind pressure increases.

The spiral spring 130 may be manufactured to have a predetermined elastic force or a predetermined elastic coefficient with which the blade 240 can rotate in such a way that the area which receives wind pressure decreases. In addition, the blade 240 may be installed to be behind the blade installation part 250 since the blade installation part 250 defines the head thereof, thus operating like the tail wing. To this end, from the rotation-inhibited blade installation part 250, the rotation angle, namely, the pitch can be easily and quickly changed based on the size of the level of wind velocity with the aid of relative rotation between the shaft 110 and the housing 120.

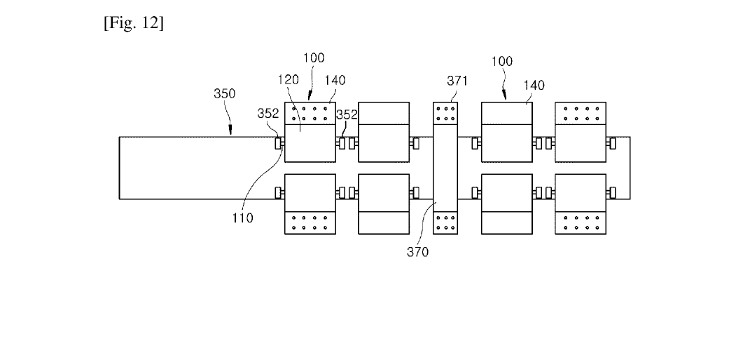

FIG. 11 is a side view illustrating a major compartment of a wind power generator which equips with a blade angle control apparatus according to a second exemplary embodiment of the resent invention. FIG. 12 is a side view illustrating an inner configuration of a blade installation part of a wind power generator which equips with a blade angle control apparatus according to a second exemplary embodiment of the present invention.

Referring to FIGS. 11 and 12, the wind power generator 300 which equips with the blade angle control apparatus according to a second exemplary embodiment of the present invention is a vertical shaft type wind power generator wherein the shaft of the rotor is vertical. A blade 340 may be installed at the upper and lower sides of the blade installation part 350, which is fixed horizontal at the hub 330, with the aid of the blade angle control apparatus 100 of a wind power generator. The blade angle control apparatus 100 of the wind power generator may be fixed multiple in number in a row in such a way to inhibit the rotations by means of the shaft fixing part 352 disposed at the blade installation part 350. Each blade fixing plate 140 may be fixed at a side portion of the blade 340. The blade angle control apparatus 100 of the wind power apparatus may be installed multiple in number at the blade installation part 350, each of which apparatuses is fixed at the blade 340, whereupon the rotational return of the blade 349 can be stably obtained. Meanwhile, a control box 370 may be installed at the blade installation part 350, and the fixing piece 371 disposed at the control box 370 can be fixed at the blade 340.

The blade 340 may include an interference prevention part 341 so as to prevent any interference when rotating upward and downward. The blade 340 may include an assistant wing 360 so as to enhance the driving efficiency with respect to wind power. This assistant wing 360 may be attached to one side surface of the blade 340 with the aid of the wing fixing piece 361. In addition, the assistant wig 360 may be connected to the wing fixing piece 361 with the aid of the blade angle control apparatus 100 of the wind power generator. For example, in the blade angle control apparatus 100 of the wind power generator, the shaft 110 may be fixed at the wing fixing piece 361, and the blade fixing plate 140 may be fixed at the assistant wing 360.

The wind power generator 300 which equips with the blade angle control apparatus according to a second exemplary embodiment of the present invention has the same operations as the wind power generator 200 which equips with the blade angle control apparatus according to the first exemplary embodiment of the present invention except for that the rotary shaft of the rotor is arranged horizontal. Like the present embodiment, the number of the blades 340 may be two in dual-leaf structure, and the number thereof is not limited thereto. The number of the blades may be 1 or at least 3.

The operations of the blade angle control apparatus of a wind power generator and the wind power generator having the same will be described mainly referring to the wind power generator 200 which equips with the blade angle control apparatus according to the first exemplary embodiment of the present invention.

The force that the wind power generator 200 receives may change based on wind velocity and the area of the blade 240, which receives wind pressure. It is hard to artificially control wind velocity. The area of the blade 240 can be controlled with the aid of the blade angle control apparatus 100 of a wind power generator. To this end, in order to enhance power generation efficiency by adjusting the pitch of the blade 240 based on the level of wind velocity, if the wind velocity is low, the area of the blade 240 to which wind pressure applies is increased, and if the wind velocity is high, the area of the blade 240 to which wind pressure applies is decreased. In this way, it is possible to prevent the blade 40 from being bent or broken by strong wind or the gear box or the shaft member or the generator disposed in the wind power generator 200 from being damaged.

The blade 240 may position at a rear side of the blade installation part 250 with respect to wind direction so that the blade installation part 250 can operate as a head, thus performing the role of a tail wing, while preventing the angle in the rotation direction at the front surface from changing. To this end, a fast and stable rotation can be obtained with respect to any change in the wind velocity when the blade angle control apparatus 100 of the wind power generator is operating, whereupon the wind velocity-based optimum toque can be generated, which results in the maximized power generation efficiency.

The time when the blade 240 rotates by the elastic force of the spiral spring 130 by the blade angle control apparatus 100 of a wind power generator can be adjusted based on the area and wind velocity of the blade 240. Even though the wind velocity is low, the area of the blade 240 to which the wind pressure applies can be increased, thus stably generating torque. In this way, the angle of the blade installation part 250 corresponding to the head crown of the blade 240 does not change, and the angle of only the blade 240 which plays a role of the tail wing formed behind the same changes based on the level of wind velocity. The blade 240 can rotate only if the wind velocity is higher than a predetermined level by the elastic force of the spiral spring 130, thus enhancing the efficiency of wind power generation. In this case, the efficiency can be enhanced based on the kinds of the wind power generator.

In addition, a plurality of the blade angle control apparatuses 100 of a wind power generator may be configured to supply elastic force to the blade 240, so the force that the blade 240 withstands wind pressure may correspond to the multiple times of such number. If angle changes at a predetermined wind velocity, the level obtained by multiplying, by the number of the blade angle adjusting apparatuses 100 of a wind power generator, the force required when further winding the spiral spring 130 in a state where the blade 240 is stopped by the stopper 161 and the engaging piece 162 may be smaller than or be same as the value obtained by multiplying the wind velocity by the area (m²) of the blade 240 which receives wind pressure.

As the present invention may be embodied in several forms without departing from the spirit or essential characteristics thereof, it should also be understood that the above-described examples are not limited by any of the details of the foregoing description, unless otherwise specified, but rather should be construed broadly within its spirit and scope as defined in the appended claims, and therefore all changes and modifications that fall within the meets and bounds of the claims, or equivalences of such meets and bounds are therefore intended to be embraced by the appended claims.

To achieve the above objects, according to one aspect of the present invention, there is provided a blade angle control apparatus of a wind power generator which is able to control the angle of a blade of the wind power generator based on wind velocity, which may include, but is not limited to, a shaft; a housing wherein the shaft is installed rotatable; and a spiral spring the ends of which are fixed at the shaft and the housing, thus storing an elastic energy based on relative rotation between the shaft and the housing, and if the force necessary for the relative rotation is removed, the spiral spring allows the shaft and the housing to relatively rotate in the opposite directions to return to their initial states, and any of the shaft and the housing is fixed at a blade installation part installed in such a way that the blade can rotate by wind pressure, and the other one is fixed at the blade, whereupon the area of the blade which receives wind pressure can be adjusted based on the level of wind velocity with the aid of the elastic force of the spiral spring.

The shaft is fixed in the longitudinal direction at the blade installation part disposed at the hub while extending in the radial direction about the hub of the wind power generator, and the housing is arranged in such a way that a blade fixing plate fixed at the blade can protrude from a side portion.

The spiral spring is installed in the inside of the housing while covering the shaft wherein one end of the spiral spring is fixed at the shaft, and the other end thereof is fixed at an inner side surface of the housing, and the shaft is supported rotatable by a bearing installed in the inside of the housing to position at both sides of the spiral spring.

There are further provided a stopper which is arranged protruding from the shaft; and an engaging piece which is installed in the housing and in a rotation trajectory of the stopper and is hooked by the stopper in such a way that the area which receives wind pressure with respect to the blade does not get out of a predetermined size, and the engaging piece is selectively fixed at any of multiple positions within the rotation trajectory, and the maximum size of the area that the blade receives wind pressure can be adjusted.

To achieve the above objects, according to another aspect of the present invention, there is provided a wind power generator having a blade angle control apparatus, which may include, but is not limited to, a hub which is installed rotatable at a nacelle; a blade installation part which extends in a radial direction about the hub and is fixed in such a way that its rotation can be inhibited; a blade angle control part which is installed at the blade installation part; and a blade which is fixed at the blade angle control part, wherein the blade angle control part is formed of a blade angle control apparatus of a wind power generator recited in any of claims 1 to 4.

The blade angle control part is installed multiple in number in the longitudinal direction at regular intervals at the blade installation part, each of the blade angle control parts being fixed at a side portion of the blade, and the blade installation part includes a blade angle control apparatus which positions at a front side of the blade with respect to wind direction.

The present invention may industrially apply to the wind power generator.

[Legends of Reference numbers]

| | |
|---|---|
| 110: Shaft | 111: Spiral spring fixing part |
| 112: Sleeve | 120: Housing |
| 121: Fixing bolt | 130: Spiral spring |
| 140: Blade fixing plate | 141: Fixing hole |
| 150: Bearing | 151: Inner race |
| 152: Outer race | 161: Stopper |
| 162: Engaging piece | 163: Fixing bolt |
| 164: Engaging groove | 210: Tower |
| 220: Nacelle | 221: Tail wing |
| 230: Hub | 240: Blade |
| 250: Blade installation part | 251: Hub fixing part |
| 252: Shaft fixing part | 253: Blocking plate |
| 254: Cover | 330: Hub |
| 340: blade | 341: Interference prevention part |
| 350: Blade installation part | 352: Shaft fixing part |
| 360: Assistant wing | 361: Wing fixing piece |
| 370: Control box | 371: Fixing piece |

1. A blade angle control apparatus of a wind power generator which is able to control the angle of a blade of the wind power generator based on wind velocity, comprising:
a shaft;
a housing wherein the shaft is installed rotatable; and
a spiral spring the ends of which are fixed at the shaft and the housing, thus storing an elastic energy based on relative rotation between the shaft and the housing, and if the force necessary for the relative rotation is removed, the spiral spring allows the shaft and the housing to relatively rotate in the opposite directions to return to their initial states, and
any of the shaft and the housing is fixed at a blade installation part installed in such a way that the blade can rotate by wind pressure, and the other one is fixed at the blade, whereupon the area of the blade which receives wind pressure can be adjusted based on the level of wind velocity with the aid of the elastic force of the spiral spring.

2. The apparatus of claim 1, wherein the shaft is fixed in the longitudinal direction at the blade installation part disposed at the hub while extending in the radial direction about the hub of the wind power generator, and the housing is arranged in such a way that a blade fixing plate fixed at the blade can protrude from a side portion.

3. The apparatus of claim 1, wherein the spiral spring is installed in the inside of the housing while covering the shaft wherein one end of the spiral spring is fixed at the shaft, and the other end thereof is fixed at an inner side surface of the housing, and the shaft is supported rotatable by a bearing installed in the inside of the housing to position at both sides of the spiral spring.

4. The apparatus of claim 1, further comprising:
a stopper which is arranged protruding from the shaft; and
an engaging piece which is installed in the housing and in a rotation trajectory of the stopper and is hooked by the stopper in such a way that the area which receives wind pressure with respect to the blade does not get out of a predetermined size, and the engaging piece is selectively fixed at any of multiple positions within the rotation trajectory, and the maximum size of the area that the blade receives wind pressure can be adjusted.

5. A wind power generator having a blade angle control apparatus, comprising:
a hub which is installed rotatable at a nacelle;
a blade installation part which extends in a radial direction about the hub and is fixed in such a way that its rotation can be inhibited;
a blade angle control part which is installed at the blade installation part; and
a blade which is fixed at the blade angle control part,
wherein the blade angle control part is formed of a blade angle control apparatus of a wind power generator recited in claim 1.

6. The generator of claim 1, wherein the blade angle control part is installed multiple in number in the longitudinal direction at regular intervals at the blade installation part, each of the blade angle control parts being fixed at a side portion of the blade, and the blade installation part includes a blade angle control apparatus which positions at a front side of the blade with respect to wind direction.
